(19) United States
(12) Patent Application Publication
(10) Pub. No.: US 2013/0191365 A1
(43) Pub. Date: Jul. 25, 2013

(54) Method to search objectively for maximal information

(71) Applicant: Mauritius H.P.M. van Putten, Cambridge, MA (US)

(72) Inventor: Mauritius H.P.M. van Putten, Cambridge, MA (US)

(21) Appl. No.: 13/354,196

(22) Filed: Jan. 19, 2012

(51) Int. Cl. G06F 17/30

(52) U.S. Cl. 707/709; 707/752; 707/748; 707/E17.108

(57) ABSTRACT

A method is disclosed for extracting maximal information in the output of document searches by key word queries. The method is based on Shannon information theory for objective ranking of the results. The data base may be unlinked, such as documents distributed over directories on a PC, or linked, such as the world-wide web. Approximate expressions for the Shannon information are disclosed using the existing word-frequencies in the natural language. The method enables numerical ranking of a list of concordances with footnotes referencing their source documents. Relatively extended concordances may be used for display on computer screens, or relatively short concordances for display on mobile devices.

### FIELD OF THE INVENTION

This invention relates generally to techniques for extracting information from large digital data bases by key word queries. Specifically, it relates to extracting search results, ranked by their Shannon information content and output in the form of concordances.

### BACKGROUND OF THE INVENTION

With the advance of digital data bases and the Internet as a general source of information, efficient extraction and presentation of search results becomes ever more paramount. A concise and user-friendly output is increasingly important with the advance of compact mobile devices.

The Internet in particular represents a heterogeneous data-base of facts, news and opinions. Searching for objective reference information using existing Internet search engines produces results that are biased towards consensus or popularity of the web-pages containing the information, rather than produced as a function of information without regards to its public connotation. While popularity of information is a useful factor in searches related to commercial topics, it can give vastly skewed results when non-commercial topics are concerned. This may explain the success of homogeneous and commercially neutral data-bases such as Wikipedia. In addition, a user may be searching for potentially useful information, that has hitherto remained out of the limelight or that may represent an emerging trend. In particular, a user may be seeking objective information for informative decision making by in-depth queries, untainted by popular belief. The latter may involve performing a deep web search, tracing one hyperlink after another, that may involve documents having relatively few links.

Internet searches are increasingly performed using smart phones and compact mobile devices. This development puts increasing pressure on developing clean and concise formatting of Internet search results, that minimize non-essential information and the need for iterative searches.

Similar discussions on the drawback of existing search engines based on ranking pages can be found in U.S. Pat. No. 7,814,099, e.g., in favoring old pages; in U.S. Pat. No. 7,934,152, e.g., in flooding devices with information that overwhelm their screen capabilities; in U.S. Pat. No. 7,676,464, e.g., on the limitations of document voting-based strategies.

Since existing search engines use ranking of pages for ranking of output results, they produce one brief extract per document or web page in their output to the user. In contrast, a search engine whose results are ranked by information content may produce a plurality of brief extracts from a single document in their output to the user. This serves to highlight a key difference in scope and output between existing search engines in the present disclosure.

The Shannon theory of information describes an objective measure for information in terms of the number of bits needed for encoding a message, after removing redundancies. Let T={wᵢ}ᵢ₌₁^{N} represent a string of N words extracted from a text document. From large numbers of documents, the relative frequency of word in the natural language are known. The results can be normalized to obtain a probability p(w) of a word w occurring in the natural language. If words in T were to be chosen blindly from a dictionary A according to the probability distribution p(w), then the information per word in T is given by Shannon's formula

I[T]=−Σ_{w}_{ᵢ}_{εT}p(wᵢ)log p(wᵢ). (1)

Note that (1) is invariant under permutations of the words wᵢ in T. In reality, text appearing in the natural language is not invariant with respect to permutations. For instance, if the words “apple” and “tree” appear in a sentence, then most often but not always “apple” appears before “tree,” possibly with one or a few words in between. Also, “purple apple” is a forbidden word combination, i.e., generally considered meaningless, whence the probability of this word combination appearing in a text is essentially nil. It follows that (1) is an upper bound on the true information in a text T due to redundancy arising from word correlations in the natural language.

It should be emphasized that (1) utilizes word frequencies in the natural language, distinct from using word frequencies as they arise in a single document, see, e.g., U.S. Pat. Nos. 7,376,649 and 7,844,602.

It should be emphasized that direct application of the Shannon information (2) of T, formally defined by (Shannon, 1948, and Shannon & Weaver, 1949)

SI[I]=−Σ_{w}_{ᵢ}_{εT} log p(wᵢ), (2)

is prohibitive in real-word applications to arbitrary text such as retrieved from the Internet due to its singular behavior for p(w)=0 for words w not in A, given that A is never complete in practice. In this disclosure, we specifically focus on approximate regularized Shannon information such as (1) which extends to the working domain p(w)≧0, in distinction to using the singular expression (2) such as proposed by Tang et al. (2011).

Calculating the exact Shannon information of a text by taking incorporating word correlations is challenging. However, the present disclose is focused on using (1) or approximations thereto for the purpose of a numerical ranking of different elements T₁ and T₂ of text, to decide which is more informative. When N is sufficiently large, we expect, without formal proof, that there is a natural cancellation of redundancies, which tends to preserve a linear ordering of the kind

I[T₁]>I[T₂], (3)

provided that I[T₁] and I[T₂] are not too close. If I[T₁] and I[T₂] are close, (3) may not be preserved upon considering more exact calculations of their Shannon information. However, in this event, the difference in their information content may, for all practical purposes, well be within the range of uncertainty of what defines a meaningful distinction to the user.

Concordances are an age old format for indexing large bodies of text, the first ones having been developed manually for religious texts. They serve as concise waypoints to highlight the contextual meaning of key words as they appear in the source document. In modern setting, the popularity of Twitter's 135 character limit serves to demonstrate the potential power of brief contextual expressions. In the present context, concordances can be readily produced by computer and formatted in any custom-made fashion, e.g., with a user-defined number of word length N. For a single document, concordances can be efficiently generated and produced on a screen for inspection by a reader. For a large data base, e.g., the works of Shakespeare or, more generally, the world-wide web, the number of concordances even for a multi-word query can be huge. In this event, ranking of concordances becomes essential, in using them for presenting search results.

### OBJECTS AND SUMMARY OF THE DISCLOSURE

It is an objective of the present invention to extract maximal information from a search query and to rank multiple search results objectively, and broadly so in accord with Shannon information theory. It is another objective to use a flexible format of search results in the form of concordances, each containing the user query of key words, whose length may be adapted to the display at hand. Thus, relatively long concordances may be presented on the screen of a desk top computer and relatively short concordances may be presented in a compact display on a mobile, hand-held device. It is a further objective to disclose a preferred embodiment, generally using an Internet browser as a user-interface, which aims at rapid execution of the required computer operations. For searches involving a limited number of documents, a personal computer may suffice. However, for comprehensive searches involving a large number of documents the preferred embodiment may be a remote execution in the form of a software-as-a-service (SAAS), by access to an Internet search provider or using a cloud computing environment.

To accomplish these and other objectives, the present invention comprises an efficient computation of the Shannon information of a concordance using approximate formulas, whose practical use are demonstrated by experiment rather than seeking accurate formulae for Shannon information in the natural language by detailed corrections for redundancy. One such approximation is given by (1). Another approximation is the reduced sum

I[T′]=Σ_{w}_{ᵢ}_{εT′}p(wᵢ)log p(wᵢ), (4)

where T′ denotes the collection of all distinct words in T. Like (1), (4) is a regular expression for all p(w)≧0 and it more closely estimates the burst rate of information in a concordance. Using either (1), (4) or a numerical combination of either, the presented invention ensures an objective ranking that, when applied to web pages retrieved from a list of hyperlinks produced by any of the existing Internet search engines, is insensitive to popularization. A selection of the top listed concordances ranked according to their approximation Shannon information to the user may be accompanied by a hyperlink to the source web page for the purposes of reference to the user.

It is an object of the present disclosure to demonstrate that the present invention gives informative results whose ranking is different from that used by existing search algorithms by statistical analysis of a comparison of their search results.

This brief description serves as a roadmap to the more detailed description that follows, in order to facilitate an understanding of the present contributions to the art, its departure from existing practices and which will be for the subject matter of the claims. It is understood that the invention is not limited in its application to the details of the method set forth in the description. The preferred embodiments are given for a realization based on the existing state of the art in hardware and software, but otherwise the invention may allow for a variety of other embodiments.

The following description is presented to enable a person of ordinary skill in the art to implement and employ the invention, and is provided in the context of documents on a computer or a collection of digital documents obtained from the world-wide web from a list of hyperlinks produced by any of the existing Internet search engines. Various modifications to the described embodiments will be readily apparent to those skilled in the art and the general principles defined herein may be applied to other embodiments without departing from the nature and scope of the present invention. Accordingly, the present intended is not intended to be limited to the specific embodiments described herein, but to be accorded to the widest scope consistent with the principles and features disclosed herein.

### SURVEY OF THE DRAWINGS AND EXAMPLES

FIG. 1 shows a statistical overview of the asymptotic behavior in search results in response to the key words “apple” and “tree,” expressed in terms of concordances of N=50 words ranked by their information content as a function of the number of web pages analyzed. Here, approximate Shannon information “ASI₁” and “ASI₂” of each concordance is defined by equation (1) and, respectively, equation (4). The data shown represent the mean of the ASIᵢ (i=1, 2) over the 30 top ranked concordances. The web pages used are produced by an existing Internet search engine based on ranking pages by popularity in the world wide web using a page ranking algorithm (U.S. Pat. No. 6,285,999).

FIG. 1. shows that for the query “apple” and “tree” it generally suffices to analyze the first few hundred pages produced by existing search engines to obtain concordances with close to maximal information content. FIG. 1 further shows that the first few web pages produced by existing search engines do not produce maximal information content, further to be detailed in FIG. 2 given below. According to these statistical results, the approximations (1) and (4) are strongly correlated, and hence are expected to produce closely related though not necessarily identical results.

FIG. 2 shows search results with the same parameters as in FIG. 1, i.e., in response to the query “apple” and “tree” and using N=50 for the output concordances. The results are shown for both ASI₁ (top four windows) and ASI₂ (bottom four windows). FIG. 2 shows that the concordances with optimal information are concentrated in the tail of the distribution of the ASIᵢ (i=1, 2) containing relatively few elements. The most relevant concordances, therefore, tend to comprise a top list of up to tens of elements, but not hundreds of elements. FIG. 2 shows that there is essentially no correlation between the ranking of concordances by their information content and the ranking of web pages as utilized in existing search engines.

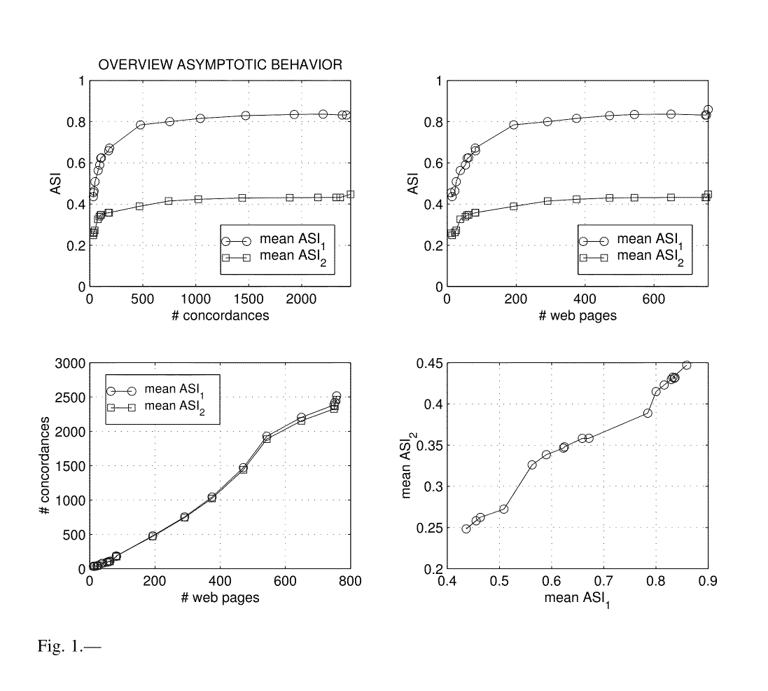

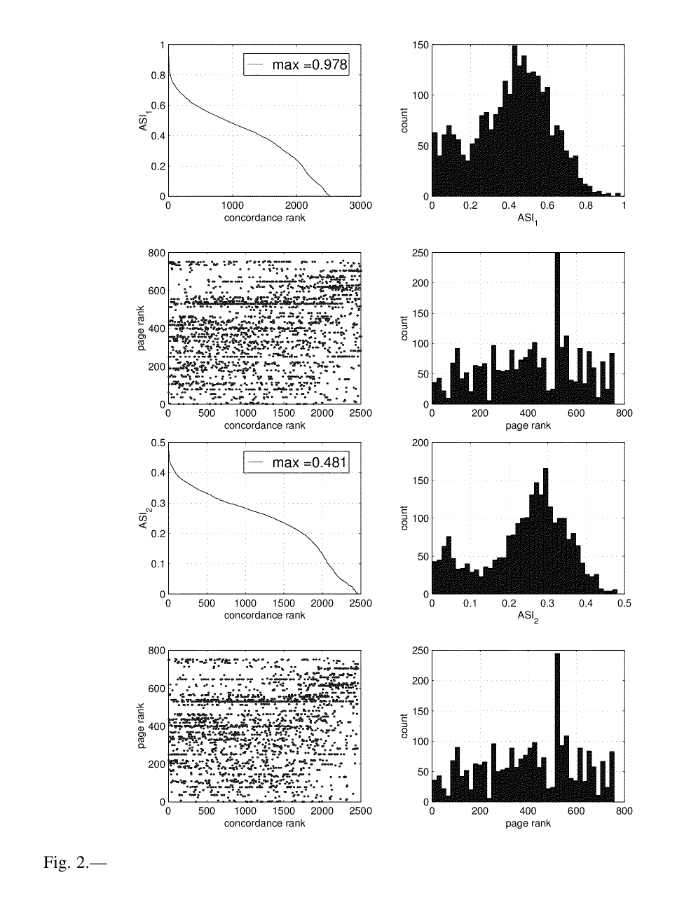

The statistical results of FIGS. 1 and 2 serves to demonstrate the power of the present method for extracting maximal objective information, compared with search methods based on existing page ranking algorithms.

Next, we show the actual output in the form of a list of concordances ranked by the ASI₁ in A1 and A2 and ranked by ASI₂ in B1 and B2, as extracted from a list of web pages produced by an existing Internet search engine. In each listing, we append the numerical value of ASIᵢ (i=1, 2) and the web page p.n indicated by its rank n as provided by the Internet search engine.

A1. Top three concordances containing “apple” and “tree” with word length N=50 ranked according to the approximate Shannon information ASI₁, extracted from the first 11 web pages produced by an existing Internet search engine:
1. . . . plant the apple tree first dig a hole approximately twice the diameter of the root system and 2 feet deep. Place some of the loose soil back into the hole and loosen the soil on the walls of the planting hole so the roots can easily penetrate the soil. Spread the tree roots on . . . (ASI₁=0.785386086, p. 7)
2. . . . the domestic apple—an issue that had been long-debated in the scientific community. 7 HistoryWild Malus sieversii apple in Kazakhstan The center of diversity of the genus Malus is in eastern Turkey. The apple tree was perhaps the earliest tree to be cultivated 8 and its fruits have been improved . . . (ASI₁=0.606088877, p. 1)
3. . . . . Malus sieversii apple in Kazakhstan The center of diversity of the genus Malus is in eastern Turkey. The apple tree was perhaps the earliest tree to be cultivated 8 and its fruits have been improved through selection over thousands of years. Alexander the Great is credited with finding dwarfed apples in . . . (ASI₁=0.573613644, p. 1)

A2. Top three concordances containing “apple” and “tree” with word length N=50 ranked according to the approximate Shannon information ASI₁, extracted from the first 96 web pages produced by an existing Internet search engine:
1. . . . to the apple tree again. Walk left and click on the tree. Cutscene. Go outside and head left. Go to the top of the big building take the ladder to the roof and jump across to the now-working elevator. Take it up. Follow the path left and right until you . . . (ASI₁=0.977773368, p. 58)
2. . . . of the apple tree in blossom is just an added bonus one that you will treasure for the rest of your life. The Gala Apple Tree is the earliest to ripen and if picked at the right time you can store them up to 6 months hellip; right off the . . . (ASI₁=0.903270841, p. 8)
3. . . . such a tree is to try to open up the interior to allow good light penetration. The first step is to remove all the upright vigorous growing shoots at their base that are shading the interior. As with the young apple trees it is necessary to select 3 to 5 . . . (ASI₁=0.786195755, p. 49)

B1. Top three concordances containing “apple” and “tree” with word length N=50 ranked according to the approximate Shannon information ASI₂, extracted from the first 11 web pages produced by an existing Internet search engine:
1. . . . When planting apple trees in a garden it is important to know that many apple trees do not self-pollinate. For this reason only one apple tree in the garden may not be able to produce much if any fruit. To solve this plant several different varieties of apple trees with . . . (ASI₂=0.381139696, p. 11)
2. . . . Turkey. The apple tree was perhaps the earliest tree to be cultivated 8 and its fruits have been improved through selection over thousands of years. Alexander the Great is credited with finding dwarfed apples in Kazakhstan in Asia in 328 BCE; 2 those he brought back to Macedonia might have . . . (ASI₂=0.348846793, p. 1)
3. . . . that many apple trees do not self-pollinate. For this reason only one apple tree in the garden may not be able to produce much if any fruit. To solve this plant several different varieties of apple trees with similar flowering times to allow for cross-pollination. Apple trees should be planted . . . (ASI₂=0.313423067, p. 11)

B2. Top three concordances containing “apple” and “tree” with word length N=50 ranked according to the approximate Shannon information ASI₂, extracted from the first 96 web pages produced by an existing Internet search engine:
1. . . . of the apple tree in blossom is just an added bonus one that you will treasure for the rest of your life. The Gala Apple Tree is the earliest to ripen and if picked at the right time you can store them up to 6 months hellip; right off the . . . (ASI₂=0.450247675, p. 8)
2. . . . a beautiful tree filled with apple blossoms in the spring and tangy sweet fruit in the fall. Just as a side note if you have problems with Codling Moth please read our article on how to get rid of this pest. We offer a home remedy as well as other . . . (ASI₂=0.423558056, p. 49)
3. . . . growing an apple tree in your garden is to pick one which will grow to the correct size and produce fruit with the taste to suit you. It's quite possible to end up with an apple tree of huge proportions in a small garden producing fruit which you don't like . . . (ASI₂=0.381817132, p. 34)

### PREFERRED EMBODIMENTS

In a personal computing environment such as used to produce FIGS. 1 and 2 and the examples A1-A2 and B1-B2, a preferred embodiment of the present disclosure is a software package running as an application in an Internet browser. The method hereby utilizes the power of a personal computer to perform the operations of
1. transmitting the user's query to one or a plurality of the existing Internet search engines;
2. downloading the web pages from the hyperlinks produced by these Internet search engines subject to limits in number and depth set by the user;
3. extracting all concordances containing the user's query from the downloaded web pages, where the concordances are limited in length set by the user;
4. calculating numerical approximations to their Shannon information;
5. sorting these according to their approximate Shannon information; and
6. presenting a top ranked list for output to the user Internet browser.

In a large data base such as the world-wide web, it is inevitable that duplicate concordances or concordances with very similar wording are produced in a typical search. To ensure the most useful presentation of results to the user, the preferred embodiment includes a filter, to suppress such redundancies for display. Operation (6) above includes a filtering of the top listed concordances with the property that each concordance displayed to the user has at least m % of its words distinct from the words in the preceding higher ranked element in C″, where m is generally more than 10. In the examples A1-A2 and B1-B2 shown, the choice m=20 has been used.

If the search is to be performed on documents stored on a local computer, the same operations (1-6) apply, except that in operation (1) the query is transmitted to the search application as provided by the operating system of a personal computer. Search applications of this kind produce a list of the names of the relevant documents and their directory locations, which obviates the need for operation (2).

In a research-oriented environment, the user may wish to perform deep web searches, that includes taking into consideration large numbers of web pages and the possibility of tracing links through the world-wide web up to a user-defined depth limit. Operations of this kind are common practice in efforts aimed at scanning the entire world-wide web by Internet search providers, but much less so by individual users because of the demand it puts on Internet bandwidth, computing power and storage. Thus, searches by the method as disclosed here are preferably performed as a “software-as-a-service” (SAAS), i.e., by providing a user with remote access to a central site, that is equipped with the necessary Internet bandwidth, hardware and storage.

In one preferred embodiment, the method as disclosed herein is embodied in a SAAS provided by an Internet search provider, who already has downloaded an appreciable fraction of the pages on the world-wide web as part of their normal course of business. In this event, the time consuming operation (2) mentioned above can be skipped. Since Internet search providers commonly work with large farms of computers, operations (3-5) can be carried out rapidly by parallel computing.

In another embodiment, the method as disclosed herein is embodied in a SAAS using cloud computing. Here, cloud computing is loosely defined as utilizing a collection of distributed computing and storage facilities equipped with the necessary cloud computing software to enable putting their combined power at work on a task servicing a single user or user group. A recent application of cloud computing is the continuous analysis of energy efficiencies by correlating real-time energy usage to the local weather (U.S. Pat. No. 7,636,666). Making dual use of a geographically distributed farm of computers offers an embodiment that is ideally suited for operations (2-5) above. Combining the partial results thus obtained from each of the nodes in the cloud for producing a final top ranked list of concordances involves negligible computing power, at one of the nodes of the cloud or at the site of the user.

For mobile devices, such as mobile phones, netbooks and tablet computers, similarly SAAS is a preferred embodiment for the method as disclosed herein in view of their limited computing and battery power. Here also, the embodiment in SAAS may comprise an Internet search provider or cloud computing as described above.

### DETAILED DESCRIPTION

In accordance with the present invention, there is provided a system and method of extracting optimal information from a data-base of documents, unlinked as when stored in directories on a computer or in an intranet, or linked such as on the world-wide web or hypermedia data-base. The system disclosed herein comprises creating a list of concordances containing a user-defined set of key words and ranking the list of concordances according to their information content. The system measures the information content of a concordance by a numerical approximation of its Shannon information. The present invention can be used to generate a ranked order of results for efficient presentation of information to the user.

The system applies to searches in a data-base D, that may be unlinked or linked as stated above. The system is controlled by a user, who submits a query comprising one or a plurality of key words K and the maximum length N of the concordances containing K. For a search on the world-wide web, the method can be further parametrized by a maximum number of web-pages and maximum link-depth. The system performs a search of D and identifies the documents D′ that contain the key words K. The system subsequently searches D′ and produces a list of concordances C, each of length up to N and containing K. The system subsequently performs a ranking of C by numerical approximation of the Shannon information in each element of C. The system subsequently sorts the elements T, (i=1, 2, . . . ) of C according to their rank. From the sorted list, that we shall refer to as C′, the system presents the top few elements to the user on a user-interface, where each element presented is accompanied by a reference to its source document or hyperlink to the source web page. In particular, a preferred output format of the top listed concordances {Tᵢ}ᵢ₌₁^{l} in C′, where l is generally a small number commensurate with the size of the display,

$$\begin{matrix}{T}_{1} ( I [ {T}_{1} ] , < reference or hyperlink to source of {T}_{1} > ) \\ {T}_{2} ( I [ {T}_{2} ] , < reference or hyperlink to source of {T}_{2} > ) \\ {T}_{3} ( I [ {T}_{3} ] , < reference or hyperlink to source of {T}_{3} > ) \\ … \\ {T}_{l} ( I [ {T}_{l} ] , < reference or hyperlink to source of {T}_{l} > ) \\ with & ( 5 ) \\ I [ {T}_{1} ] > I [ {T}_{2} ] > I [ {T}_{3} ] > … > I [ {T}_{l} ] . & ( 6 )\end{matrix}$$

Here, I[Tⱼ] represents a numerical approximation of its Shannon information according to either (1) or (4).

As a preferred embodiment, rather than seeking detailed corrections for semantic redundancy in concordances, we utilize (1) or (4) in view of its ease of calculation. Thus, (1) or (4) is computed by calculating the sum using a tabulated list of values of p(w) of common words in the natural language. For the English language, lists of relative frequencies of the most common words are readily available on the Internet or can be acquired from commercial vendors. Such lists are effectively complete. While very rarely used words, e.g., of not well known places such as Newton's birth place Woolsthorpe, are typically not included, their probability of occurrence is sufficiently low to contribute negligibly to the sum should they do appear.

In presenting items from the top of the list of C′ as given in (5) to the user, it is generally advantageous to include only those, that are sufficiently distinct to avoid multiplicities that are essentially similar. A selection of items that is readily implemented by computer is the extracting of a top list of concordances C″ from (5) for display to the user with the property that each concordance has at least m percent of its N words distinct from the words in the preceding higher ranked element in C″. In generating the examples A1-A2 and B1-B2 above, m=20 is used.

### REFERENCES

www.opensourceshakespeare.org/concordance
Shannon, C. E., 1948, Bell Syst. Tech. J. 27(379), 623
Shannon, C. E., & Weaver, W., 1949, The Mathematical Theory of Communication. University of Illinois Press, Urbana
U.S. Pat. No. 6,285,999, 2001, Page, L.
U.S. Pat. No. 7,376,649, 2008, Yang, T., Wang, W., & Gerasoulis, A.
U.S. Pat. No. 7,676,464, Laker, M. M., Lencher, J., & Milch, D., 2010
U.S. Pat. No. 7,814,099, Wang, L. S., 2010
U.S. Pat. No. 7,844,602, Katwala, N., Patton, N., & Pump, J., 2010
U.S. Pat. No. 7,934,152, Krishnamurthy, A., Singh, J. P., Wang, R., & Yu, X., 2011
U.S. Pat. No. 7,636,666, van Putten, M. H. P. M., et al., 2009
US-2011/0055192 A1, Tang, Y. T., et al., 2011

What we claim is:

1. (canceled)

2. (canceled)

3. A method for extracting maximal objective information from a data-base of documents D initiated by a search query of key words K in terms of a top list of concordances Tⱼ (j=1, 2, . . . ) each containing K controlled by a maximal word-length N, where said list is ranked according to an approximate Shannon information rate I[Tⱼ] of each said Tⱼ comprising the steps:
extracting a list of concordances Tⱼ with maximal word length N from D each containing K by existing digital document search methods;
obtaining the probability p(wᵢ) of each word wᵢ in the Tⱼ (i=1, 2, . . . , N) from a tabulated list of relative word frequencies of the words in the natural language;
computing the I[Tⱼ] from the sum of the products −p(wᵢ) log p(wᵢ) over all words wᵢ in each Tⱼ;
producing a top list of said concordances sorted by rank according to said I[Tⱼ] for display to the user.

4. A method for extracting maximal objective information from a data-base of documents D initiated by a search query of key words K in terms of a top list of concordances Tⱼ (j=1, 2, . . . ) each containing K controlled by a maximal word-length N, where said list is ranked according to an approximate Shannon information rate I[Tⱼ] of each said Tⱼ comprising the steps:
extracting a list of concordances Tⱼ with maximal word length N from D each containing K by existing digital document search methods;
obtaining the probability p(wᵢ) of each word wᵢ in the Tⱼ (i=1, 2, . . . , N) from a tabulated list of relative word frequencies of the words in the natural language;
computing the I[Tⱼ] from the sum of the products −p(wᵢ) log p(wᵢ) over all distinct words wᵢ in each Tⱼ;
producing a top list of said concordances sorted by rank according to said I[Tⱼ] for display to the user.

5. A method for extracting a ranked list of concordances according to the approximate Shannon information rate in claim 3 further comprising the extraction of a sub-list of concordances for display to the user from said ranked concordances with the property that each concordance in said sub-list has at least m percent of its words distinct from the words in the preceding higher ranked element, where m is generally more than 10.

6. The method for extracting a ranked list of concordances with maximal information from the world-wide web as in claim 5, further comprising: displaying an extended list of top ranked concordances with a relatively large word-length adapted for in-depth presentation on personal computer screens, where the number of the concordances displayed on said computer screen is generally three or more and said word-length is generally tens of words.

7. The method for extracting a ranked list of concordances with maximal information from a data-base of documents D as in claim 3, further comprising: displaying the first few top ranked concordances with relatively small word-length adapted for economical presentation on compact mobile devices, where the number of the concordances displayed on said computer screen is generally on the order of three and said word-length is generally on the order of ten.

8. The method for extracting a ranked list of concordances with maximal information from the world-wide web according to claim 3, further comprising: executing remotely said processes of downloading, extracting concordances, numerical computing and sorting of concordances by way of software-as-a-service conducted by an Internet search provider or by using cloud computing.

9. A method for extracting a ranked list of concordances with maximal information from a data-base of documents D initiated by a search query consisting of key words K and presenting search results in terms of a top list of concordances each containing K controlled by a maximal word-length N according to claim 3 further comprising:
identifying to each concordance the source document D′ in said data-base D;
including a reference to source document(s) to each concordance in said a top list of concordances.

10. A two-dimensional Internet search method parameterized by a user-defined maximal word-length N of concordances according to claim 3 further comprising
a user-defined search depth L applied to the documents on the world-wide web;
creating a set of hyperlinks H pointing to a list of documents each containing the key words K by submitting K as a query to one or a plurality of Internet search engines;
obtaining a set D′ of documents by downloading the web-pages pointed to by the first L of said hyperlinks H, where said L is generally a few up to a few hundred;
executing subsequently the steps given in claim 4.

11. A method for extracting a ranked list of concordances according to the approximate Shannon information rate in claim 4 further comprising the extraction of a sub-list of concordances for display to the user from said ranked concordances with the property that each concordance in said sub-list has at least m percent of its words distinct from the words in the preceding higher ranked element, where m is generally more than 10.

12. The method for extracting a ranked list of concordances with maximal information from the world-wide web as in claim 11, further comprising: displaying an extended list of top ranked concordances with a relative large word-length adapted for in-depth presentation on personal computer screens, where the number of the concordances displayed on said computer screen is generally three or more and said word-length is generally tens of words.

13. The method for extracting a ranked list of concordances with maximal information from a data-base of documents D as in claim 4, further comprising: displaying the first few top ranked concordances with relatively small word-length adapted for economical presentation on compact mobile devices, where the number of the concordances displayed on said computer screen is generally on the order of three and said word-length is generally on the order of ten.

14. The method for extracting a ranked list of concordances with maximal information from the world-wide web according to claim 4, further comprising: executing remotely said processes of downloading, extracting concordances, numerical computing and sorting of concordances by way of software-as-a-service conducted by an Internet search provider or by using cloud computing.

15. A method for extracting a ranked list of concordances with maximal information from a data-base of documents D initiated by a search query consisting of key words K and presenting search results in terms of a top list of concordances each containing K controlled by a maximal word-length N according to claim 4 further comprising:
identifying to each concordance the source document D′ in said data-base D;
including a reference to source document(s) to each concordance in said a top list of concordances.

16. A two-dimensional Internet search method parameterized by a user-defined maximal word-length N of concordances according to claim 4 further comprising
a user-defined search depth L applied to the documents on the world-wide web;
creating a set of hyperlinks H pointing to a list of documents each containing the key words K by submitting K as a query to one or a plurality of Internet search engines;
obtaining a set D′ of documents by downloading the web-pages pointed to by the first L of said hyperlinks H, where said L is generally a few up to a few hundred;
executing subsequently the steps given in claim 4.
